(19) United States
(12) Patent Application Publication
(10) Pub. No.: US 2008/0190129 A1
(43) Pub. Date: Aug. 14, 2008

(54) Header and chute attachment implements for header-chute assemblies of refrigeration systems

(75) Inventors: Toby Clark, Phenix City, AL (US); Michael J. McMahon, Palatine, IL (US); Stanley Piotrowski, Addison, IL (US)

Correspondence Address: Steven W. Weinrieb;LAW OFFICES OF STEVEN W. WEINRIEB, 8717 Cold Spring Road, Potomac, MD, 20854, US

(73) Assignee: ILLINOIS TOOL WORKS INC.

(21) Appl. No.: 11/705,062

(22) Filed: Feb. 12, 2007

(51) Int. Cl. F25D 19/00; F16B 5/12

(52) U.S. Cl. 62/298; 403/363

(57) ABSTRACT

Header and chute components of a refrigeration air distribution system have fastener attachment implements disposed thereon such that the header and chute components, or successive chute components, can be easily attached and detached with respect to each other by end-user customer personnel at on-site field locations. In addition, individual or particular header and chute components can be mixed and matched as may be desired, successive chute-components can be attached or detached with respect to each other in order to provide header-chute assemblies of varying length dimensions, and worn or damaged header and chute components may be readily replaced.

### FIELD OF THE INVENTION

The present invention relates generally to refrigeration systems, and more particularly to new and improved attachment implements for securing together header and chute components which are used in connection with refrigeration systems incorporated within, for example, refrigeration truck or reefer trailers, wherein the attachment implements readily permit the repeated or interchangeable attachment and detachment of any particular header component to and from any particular chute component, or the attachment and detachment of any particular chute component to and from any other chute component, without the need for specialized manufacturing assemblies. In this manner, multiple header and chute components may be maintained, for example, by the refrigeration truck or reefer trailer user or customer, and subsequently, depending upon, for example, the particular model of the refrigeration unit, or depending upon, for example, the particular configuration or design of the refrigerated air distribution chute, which is usually dependent upon, or a function of, the size of the refrigeration truck or reefer trailer, particularly desired header and chute components of the refrigeration sys-tem may be selected and readily assembled together on site or in the field by the refrigeration truck or reefer trailer end-user or customer personnel as opposed to necessarily being specially ordered from the header and chute manufacturer as a customized integral assembly.

### BACKGROUND OF THE INVENTION

In connection with refrigeration truck or reefer trailers, a chute component or body structure is utilized to distribute the cold air, emanating from the reefer or refrigeration unit, throughout the entire internal volume of the trailer, as defined by means of its lateral width, longitudinal length, and vertical height or depth. The reefer or refrigeration unit is usually mounted upon or within the front wall portion of the trailer, and the chute component or body structure is often secured upon the upper internal wall or ceiling portion of the trailer so as to extend substantially the entire length of the trailer along the ceiling centerline. In view of the fact that the multitude of commercially available reefer or refrigeration units comprise various different models having various different dimensions and configurations which do not readily permit the upstream or inlet end portion of the chute component or body structure to be attached to the cold air outlet or exhaust port end of the refrigeration or reefer unit, a header component is utilized, in effect, as a transitional structure fluidically interconnecting the cold air outlet or exhaust port end of the reefer or refrigeration unit to the upstream or inlet end portion of the chute component or body structure. More particularly, the typical header component has a substantially frusto-conical or similar geometrical configuration wherein the larger, upstream or inlet end portion of the header component is effectively adapted to be mounted upon the reefer or refrigeration unit so as to effectively encase or surround the same, while the smaller, downstream or outlet end portion of the header component is effectively adapted to be fluidically mated with or attached to the upstream or inlet end portion of the chute component or body structure. It is also to be readily appreciated that, in view of the aforenoted multiplicity of commercially available reefer or refrigeration units comprising the various different models, having the various different dimensions and configurations, then it readily follows that various different headers, having corresponding various different configurations and dimensions, must necessarily be manufactured. Still yet further, both the header and chute components may be fabricated from various different materials, having various different coatings incorporated thereon, depending, for example, upon end-user or customer specifications or intended uses, examples of such materials being a suitable vinyl, nylon, woven polyethylene, mesh-type fabrics, and the like.

Continuing further, in connection with providing the header and chute components to the end-user or customer, conventionally, the smaller, downstream or outlet end portion of the header component is permanently or fixedly attached to the upstream or inlet end portion of the chute component by means of a manufacturing process which comprises the sewing together of the header and chute components so as to in fact fabricate an integral header-chute assembly, however, this typical or conventional manufacturing process exhibits a multitude of deficiencies both from a manufacturing point of view as well as from an end-user or customer usage point of view. More particularly, and considered from the manufacturing point of view, when particular header-chute assemblies, comprising particular ones of the aforenoted header and chute components comprising particular dimensions, configurations, and materials, are to be fabricated, the header components and the chute components are initially manufactured upon two separate production lines, and subsequently, the two separate production lines are effectively merged into a single final production or assembly line wherein the separately fabricated header and chute components are assembled together by means of, for example, the aforenoted final sewing operation. It can therefore be readily appreciated that various different final production or assembly lines must be erected within one or more plant facilities in order to effectively accommodate the various different header-chute assemblies, comprising the various different header and chute components, to be manufactured or assembled together. In addition, the entire assembly process is not particularly efficient or cost-effective in view of the fact that the production rates, characteristic of the separate production lines separately manufacturing the header components and the chute components, differ from each other, thereby rendering the finalized sewing process difficult to coordinate or optimize.

Continuing still further, and considered from the end-user or customer usage point of view, each time a particular end-user or customer needs a particularly configured or particularly sized header-chute assembly for use within a particular reefer or refrigeration trailer having a particular reefer or refrigeration unit disposed within the particular reefer or refrigeration trailer having particular volumetric dimensions, the end-user or customer must effectively custom-order the particular header-chute assembly from the manufacturer. For example, it can be readily appreciated that if the end-user or customer is using two different reefer or refrigeration trailers which differ only, for example, in their length dimensions, that is, both reefer or refrigeration trailers have the same type of reefer or refrigeration unit incorporated therein which would effectively dictate the usage of the same type of header component, and wherein both reefer or refrigeration trailers have the same width and height dimensions, then the end-user or customer cannot use the same header-chute assembly within both reefer or refrigeration trailers because the length dimensions of the chute components will necessarily be different. In addition, different chute components cannot be readily exchanged within the existing header-chute assemblies because the header and chute components are fixedly assembled together, by means of the aforenoted sewing operation, as an integral entity. Accordingly, the end-user or customer is forced to custom-order two different header-chute assemblies from the manufacturer whereby the end-user or customer will experience increased inventory costs.

In a similar manner, even if the end-user or customer is using the same reefer or refrigeration trailer, having the same reefer or refrigeration incorporated therein, to ship or transport two different cargo loads during two different or separate shipments, wherein the cargo loads may require or necessitate different refrigeration parameters, the end-user or customer may desire to use two different header-chute assemblies fabricated, for example, from different combinations of the aforenoted conventional materials, however, again, the different header or chute components cannot be readily exchanged within the existing header-chute assemblies because the header and chute components are fixedly assembled together, by means of the aforenoted sewing operation, as an integral entity. Accordingly, the end-user or customer is again forced to custom-order two different header-chute assemblies from the manufacturer, thereby again experiencing increased inventory costs. Still yet further, if either the header or chute component of the particular header-chute assembly should become worn, such as, for example, as a result of normal but continued usage over extended periods of time, or if the header or chute component of the particular header-chute assembly should become damaged, such as, for example, during various handling operations by means of motorized handling equipment, such as, for example, fork lift trucks or the like, the particularly damaged header or chute components of the header-chute assemblies cannot be readily interchanged or replaced. Accordingly, the end-user or customer is again forced to custom-order an entirely new header-chute assembly from the manufacturer whereby, once again, the end-user or customer will experience increased product line costs.

A need therefore exists in the art for a new and improved header-chute assemblies, for use within refrigeration systems, having new and improved attachment implements which would not only permit the header and chute components to be readily attached to each other at on site or field locations by end-user or customer personnel, in order to fabricate the header-chute assemblies, so as to eliminate the necessity for fabricating the header-chute assemblies upon merged header component and chute component plant facility production lines, but in addition, such new and improved header and chute attachment implements would also permit the header and chute components, or successive chute components, to be readily attached and detached from each other so as to facilitate the exchange or interchangeability of various header and chute components with respect to each other.

### SUMMARY OF THE INVENTION

The foregoing and other objectives are achieved in accordance with the teachings and principles of the present invention through the provision of new and improved header-chute assemblies having new and improved attachment implements for attachably and detachably securing together the header and chute components which are to be used within refrigeration systems incorporated within, for example, refrigeration truck or reefer trailers, wherein the attachment implements readily permit the repeated or interchangeable attachment and detachment of any particular header component to and from any particular chute component, or the attachment and detachment of any particular chute component to another chute component, without the need for specialized manufacturing assemblies. In this manner, multiple header and chute components may be maintained, for example, by the refrigeration truck or reefer trailer end-user or customer, and subsequently, depending upon, for example, the particular model of the refrigeration unit, or depending upon, for example, the particular configuration or design of the refrigerated air distribution chute, which is usually dependent upon, or a function of, the size of the refrigeration truck or reefer trailer, or depending upon the particular refrigeration parameters required for transporting particular refrigerated cargo loads, particularly desired header and chute components of the refrigeration system may be selected and readily assembled together on site or in the field by the refrigeration truck or reefer trailer user or customer personnel as opposed to necessarily being specially ordered from the header and chute manufacturer as a customized integral assembly. More particularly, the new and improved attachment implements may comprise, for example, zipper-type implements, hook and loop type implements, hinge type implements, or clamp type implements.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a perspective view of a first embodiment of a new and improved header-chute assembly, constructed in accordance with the principles and teachings of the present invention, wherein the first embodiment assembly has new and improved attachment implements fixedly mounted upon the header and chute components for attachably and detachably securing together the header and chute components which are to be used in connection with refrigeration systems which are to be incorporated within, for example, refrigeration truck or reefer trailers;

FIG. 2 is a perspective view, similar to that of FIG. 1, showing, however, a second embodiment of a new and improved header-chute assembly, constructed in accordance with the principles and teachings of the present invention, wherein the second embodiment assembly has new and improved attachment implements fixedly mounted thereon for attachably and detachably securing together the header and chute components which are to be used in connection with refrigeration systems which are to be incorporated within, for example, refrigeration truck or reefer trailers;

FIG. 3 is a perspective view, similar to that of either one of FIG. 1 or FIG. 2, showing, however, a third embodiment of a new and improved header-chute assembly, constructed in accordance with the principles and teachings of the present invention, wherein the third embodiment assembly has new and improved attachment implements fixedly mounted thereon for attachably and detachably securing together the header and chute components which are to be used in connection with refrigeration systems which are to be incorporated within, for example, refrigeration truck or reefer trailers;

FIG. 4 is a perspective view, similar to that of either one of FIGS. 1-3, showing, however, a fourth embodiment of a new and improved header-chute assembly, constructed in accordance with the principles and teachings of the present invention, wherein the fourth embodiment assembly has new and improved attachment implements fixedly mounted thereon for attachably and detachably securing together the header and chute components which are to be used in connection with refrigeration systems which are to be incorporated within, for example, refrigeration truck or reefer trailers;

FIG. 5 is a perspective view, similar to that of either one of FIGS. 1-4, showing, however, a fifth embodiment of a new and improved header-chute assembly, constructed in accordance with the principles and teachings of the present invention, wherein the fifth embodiment assembly has a new and improved attachment implement mounted thereon for attachably and detachably securing together the header and chute components which are to be used in connection with refrigeration systems which are to be incorporated within, for example, refrigeration truck or reefer trailers; and

FIG. 6 is a perspective view, similar to that of either one of FIGS. 1-5, showing, however, a sixth embodiment of a new and improved header-chute assembly, constructed in accordance with the principles and teachings of the present invention, wherein the sixth embodiment assembly has a new and improved attachment implement fixedly mounted upon one of the header or chute components for attachably and detachably securing together the header and chute components which are to be used in connection with refrigeration systems which are to be incorporated within, for example, refrigeration truck or reefer trailers.

### DETAILED DESCRIPTION OF THE ILLUSTRATED EMBODIMENTS

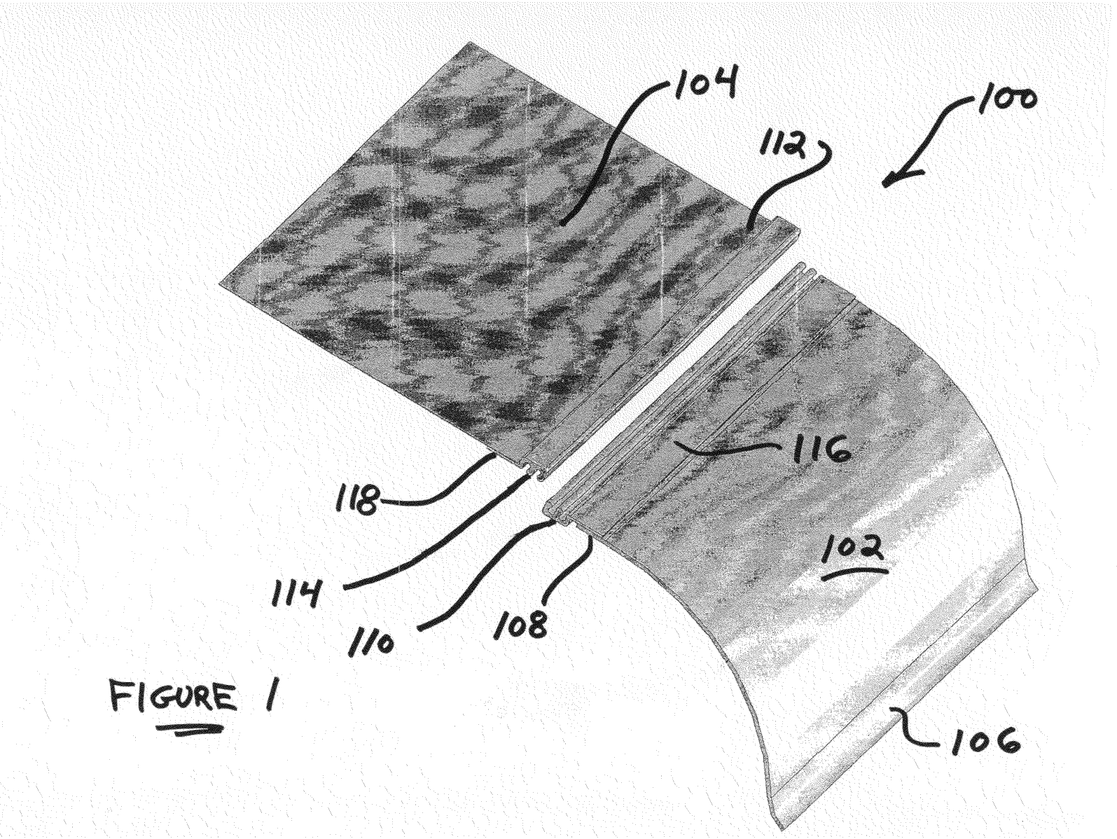

Referring now to the drawings, and more particularly to FIG. 1 thereof, a first embodiment of a new and improved header-chute assembly, having new and improved attachment implements fixedly disposed upon the header and chute components of the new and improved header-chute assembly for attachably and detachably securing together the header and chute components which are to be used within refrigeration systems incorporated within, for example, refrigeration truck or reefer trailers, and constructed in accordance with the principles and teachings of the present invention, is disclosed and is generally indicated by the reference character 100. More particularly, part of a header component of the header-chute assembly 100 is disclosed at 102, while part of a chute component of the header-chute assembly 100 is disclosed at 104. An upstream or inlet end portion 106 of the header component 102 is adapted to be mated with and mounted upon a reefer or refrigeration unit, not shown, incorporated upon or within a reefer or refrigeration trailer, and in order to render the header and chute components 102, 104 of the header-chute assembly 100 readily attachable and detachable with respect to each other so as to, for example, render the header and chute components 102, 104 capable of being readily assembled on site or in the field by refrigeration personnel of an end-user or customer, it is seen that, in accordance with the principles and teachings of the present invention, the downstream or outlet end portion 108 of the header component 102 has a first zipper-type fastener attachment implement 110 fixedly secured thereon, while the upstream or inlet end portion 112 of the chute component 104 has a second zipper-type fastener attachment implement 114 fixedly secured thereon. The first zipper-type fastener attachment implement 110 is seen to comprise an integral flanged portion 116 which is adapted to be fixedly secured upon the upper outer surface region of the downstream or outlet end portion 108 of the header component 102 by any suitable means, such as, for example, adhesive bonding, sewing, welding, riveting, or the like, and in a similar manner, the second zipper-type fastener attachment implement 114 is seen to comprise an integral flanged portion 118 which is adapted to be fixedly secured upon the lower undersurface region of the upstream or inlet end portion 112 of the chute component 104 by any one of the aforenoted suitable means, such as, for example, adhesive bonding, sewing, welding, riveting, or the like. It is to be noted that the first and second zipper-type fastener attachment implements 110, 114 are substantially identical with respect to each other, and thus, either one of such first and second zipper-type fastener attachment implements 110, 114 may actually be fixedly mounted upon either one of the header or chute components 102, 104.

Continuing further, it is also to be noted that, as a result of the aforenoted structural assembly comprising the header and chute components 102, 104, and the new and improved attachment implements 110, 114 respectively fixedly secured thereon, different header and chute components 102, 104 can be separately manufactured upon their conventional production lines, and a multiplicity of such different header and chute components 102, 104 can be separately ordered from the manufacturer and subsequently stockpiled and inventoried by means of an end-user or customer. Accordingly, when particular header and chute components 102, 104 are to be assembled together so as to effectively form a particular header-chute assembly for use in conjunction with a particular reefer or refrigeration unit disposed within or upon a particularly dimensioned reefer or refrigeration trailer, end-user or customer personnel can simply select the particular header and chute components 102, 104 from their stockpiled inventory and simply assemble the same together as a result of mating the first and second zipper-type fastener attachment implements 110, 114 thereof by manually pressing them together.

Furthermore, the header and chute components 102, 104 may be readily detached from each other, and other header or chute components 102, 104 may be respectively attached to other chute or header components 104, 102 depending upon the particular reefer or refrigeration unit to which the header-chute assembly 100 is to be operatively mated with, or depending upon the particularly dimensioned reefer or refrigeration trailer within which the header-chute assembly 100 is to be incorporated. Still further, if a particular one of the header or chute components 102, 104 should become worn or damaged, the provision of the attachable/detachable fastener attachment implements 110, 114 permits individual header or chute components 102, 104 to be simply, readily, and quickly interchanged or replaced with corresponding header or chute components 102, 104. Still yet further, while the attachable and detachable fastener attachment implements 110, 114 have been disclosed and illustrated as being respectively incorporated upon the header and chute components 102, 104, it is to be appreciated that similar attachable/detachable fastener attachment implements 110, 114 may be incorporated upon upstream or inlet, and downstream or outlet, end portions of successive chute components 104. In this manner, a particular chute component 104, having a particular length dimension, for use within, for example, any one of different reefer or refrigeration trailers having, for example, different length dimensions, can be easily, readily, and quickly assembled.

Continuing still further, it is also to be appreciated that in view of the foregoing structure characteristic of the new and improved header-chute assembly 100, having the new and improved fastener attachment implements 110, 114 mounted thereon, the need for erecting the aforenoted merged assembly line within the manufacturing or plant facilities, upon which the separately manufactured header and chute components are effectively conventionally assembled together, by means of the aforenoted sewing process, so as to fabricate the finalized header-chute assembly, is obviated, rendered unnecessary, and may be eliminated. Accordingly, manufacturing or plant facilities may be simplified or reduced in size, or alternatively, additional separate header and chute production lines may be erected and incorporated within the manufacturing or plant facilities. In addition, the manufacturing efficiencies attendant the production of the separate header and chute components may be optimized or maximized in view of the fact that each header and each chute component production line can be truly independent with respect to each other as opposed to being functionally dependent in view of the fact that the separate production lines no longer need to be ultimately coordinated for the conventional merger and assembly of the header-chute assemblies.

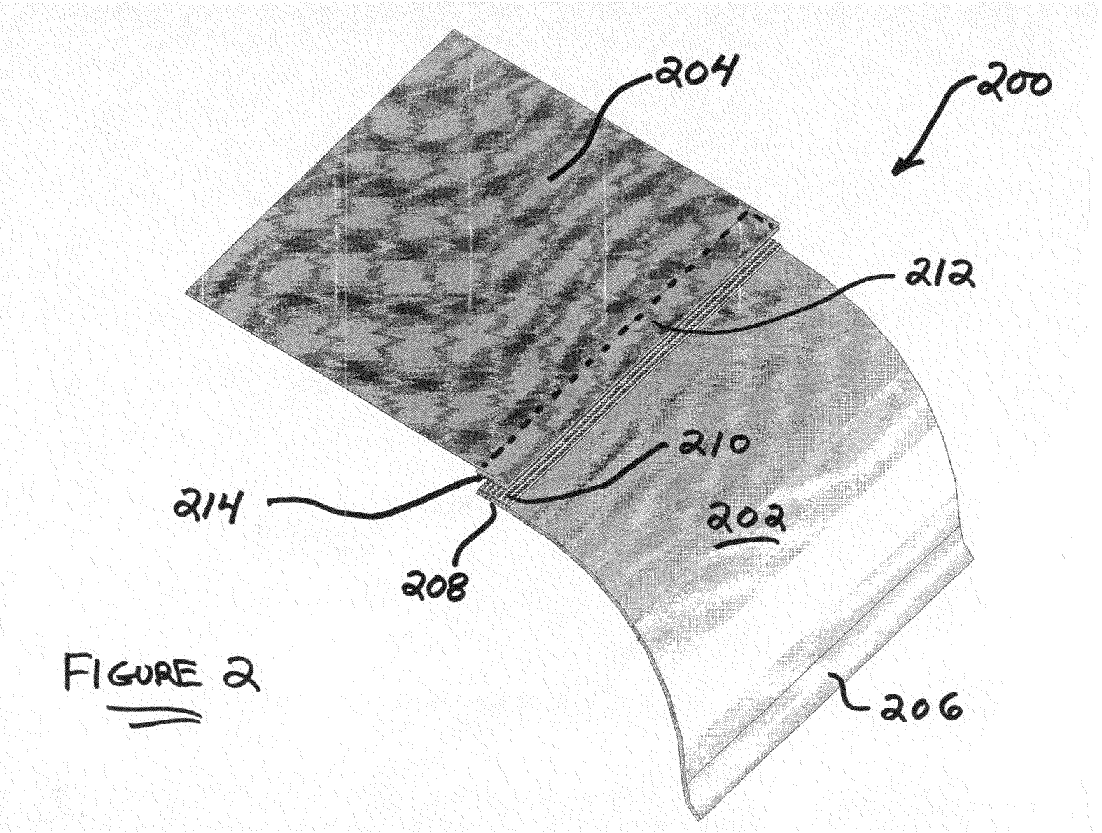

With reference now being made to FIG. 2, a second embodiment of a new and improved header-chute assembly, also constructed in accordance with the principles and teachings of the present invention and having new and improved attachment implements fixedly disposed upon the header and chute components of the new and improved header-chute assembly for attachably and detachably securing together the header and chute components which are to be used within refrigeration systems incorporated within, for example, refrigeration truck or reefer trailers, is disclosed and is generally indicated by the reference character 200. It is to be noted that the second embodiment header-chute assembly 200 is somewhat similar to the first embodiment header-chute assembly 100 as disclosed within FIG. 1, and therefore a detailed discussion of the same will be omitted herefrom for brevity purposes, the discussion of the second embodiment header-chute assembly 200 being confined to the differences between the first and second embodiment header-chute assemblies 100, 200. In addition, in view of the similarity of the first and second embodiment header-chute assemblies 100, 200, component parts of the second embodiment header-chute assembly 200, which correspond to component parts of the first embodiment header-chute assembly 100, will be designated by corresponding reference numerals except that they will be within the 200 series. More particularly, it is seen that in lieu of the zipper-type fastener attachment implements 110, 114 that were fixedly mounted upon the header and chute components 102, 104 of the first embodiment header-chute assembly 100, the header and chute components 202, 204 of the second embodiment header-chute assembly 200 are respectively provided with hook and loop fastener attachment implements 210, 214, such as, for example, VELCRO®. Accordingly, again, particular header and chute components 202, 204, or pairs of chute components 204, 204, can be easily, readily, and quickly attached to, or detached from, each other at on-site or field locations by end-user or customer personnel so as to assemble appropriate header and chute components 202, 204 together for use in connection with particular reefer or refrigeration units disposed within or upon particular reefer or refrigeration trailers, and in addition, the header and chute manufacturing operations or processes, and their production lines, can be streamlined and rendered more efficient.

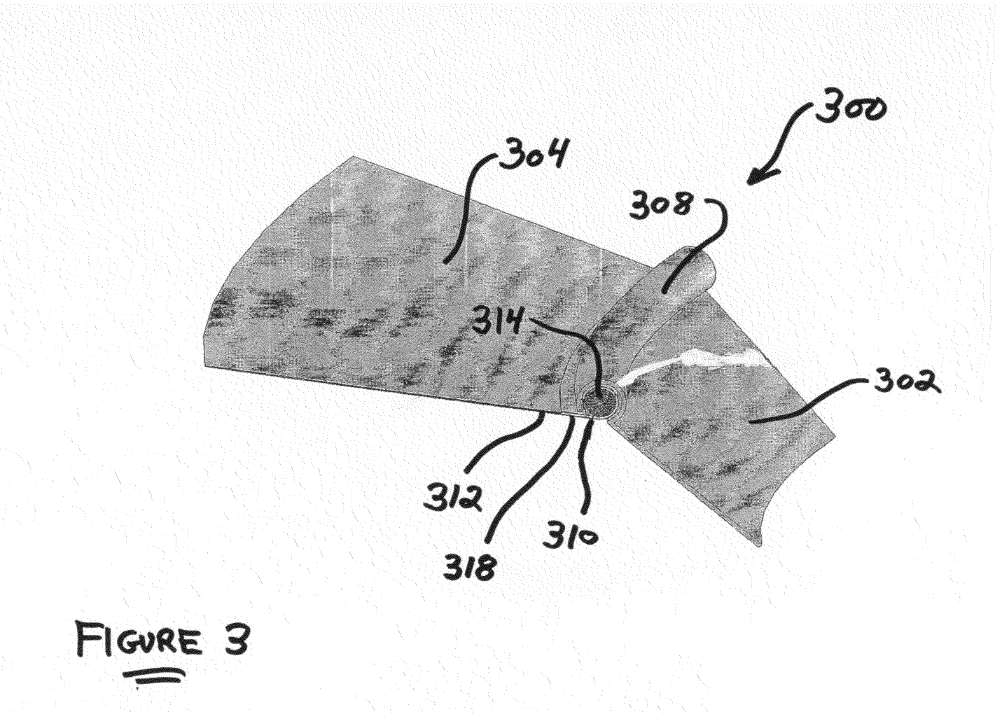

Turning now to FIG. 3, a third embodiment of a new and improved header-chute assembly, also constructed in accordance with the principles and teachings of the present invention and having new and improved attachment implements fixedly disposed upon, or integrally incorporated into, the header and chute components of the new and improved header-chute assembly for attachably and detachably securing together the header and chute components which are to be used within refrigeration systems incorporated within, for example, refrigeration truck or reefer trailers, is disclosed and is generally indicated by the reference character 300. It is to be noted that the third embodiment header-chute assembly 300 is somewhat similar to the first and second embodiment header-chute assemblies 100, 200 as disclosed within FIGS. 1 and 2, and therefore a detailed discussion of the same will be omitted herefrom for brevity purposes, the discussion of the third embodiment header-chute assembly 300 being confined to the differences between the third embodiment header-chute assembly 300 and the first and second embodiment header-chute assemblies 100, 200. In addition, in view of the similarity of the third embodiment header-chute assembly to the first and second embodiment header-chute assemblies 100, 200, component parts of the third embodiment header-chute assembly 300, that correspond to the component parts of the first and second embodiment header-chute assemblies 100, 200, will be designated by corresponding reference numerals except that they will be within the 300 series.

More particularly, it is seen that in lieu of the first and second zipper-type fastener attachment implements 110, 114 utilized within the first embodiment header-chute assembly 100, or the first and second hook and loop type fastener attachment implements 210, 214 utilized within the second embodiment header-chute assembly 200, in accordance with the principles and teachings of the third embodiment header-chute assembly 300 of the present invention, the downstream or outlet end portion 308 of the header component 302 has an arcuate female socket member integrally formed thereon, while a male member 310 is fixedly mounted upon the upstream or inlet end portion 312 of the chute component 304 by means of a flanged portion 318. The male member 310 comprises a slightly radially compressible hollow tubular member, while the arcuate female socket member 308 is also slightly radially expansible whereby, as a result of such compressibility and expansibility of the male and female members 310, 308, the male member 310 is capable of being, in effect, snap-fitted into the female socket member 308 of the header component 302. As can readily be appreciated, the internally disposed male insert member 310 is capable of under-going rotational movement with respect to the externally disposed female socket member 308, and in order to maintain the male member 310 rotationally disposed internally inside the externally disposed female socket member 308, and to prevent the inadvertent dislocation of the hollow tubular male member 310 from the female socket member 308 as a result of the hollow tubular male member 310 undergoing radial compression, and as a result of the female socket member 308 undergoing radial expansion, a locking insert member 314 is disposed internally within the hollow tubular male member 310. When, in fact, the internal hollow tubular male member 310 is to be detached from the external female socket member 308, the locking insert member 314 is axially removed from the internal hollow tubular male member 310, and the internal hollow tubular male member 310 is effectively radially compressed, while the female socket member 308 is radially expanded, so as to permit the male member 310 to effectively be removed from the female socket member 308 in a substantially snap-fitting manner.

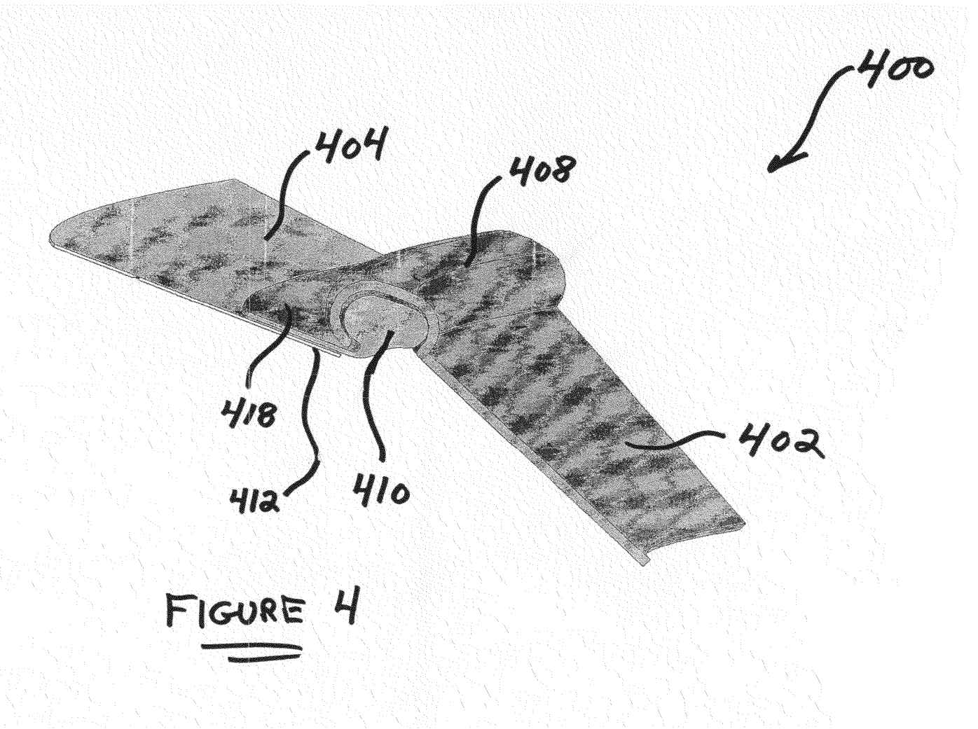

With reference now being made to FIG. 4, a fourth embodiment of a new and improved header-chute assembly, also constructed in accordance with the principles and teachings of the present invention and having new and improved attachment implements fixedly disposed upon, or integrally incorporated into, the header and chute components of the new and improved header-chute assembly for attachably and detachably securing together the header and chute components which are to be used within refrigeration systems incorporated within, for example, refrigeration truck or reefer trailers, is disclosed and is generally indicated by the reference character 400. It is to be noted that the fourth embodiment header-chute assembly 400 is somewhat similar to the third embodiment header-chute assembly 300 as disclosed within FIG. 3, and therefore a detailed discussion of the same will be omitted herefrom for brevity purposes, the discussion of the fourth embodiment header-chute assembly 400 being confined to the differences between the third embodiment header-chute assembly 300 and the fourth embodiment header-chute assembly 400. In addition, in view of the similarity of the fourth embodiment header-chute assembly 400 to the third embodiment header-chute assembly 300, component parts of the fourth embodiment header-chute assembly 400, that correspond to the component parts of the third embodiment header-chute assembly 300, will be designated by corresponding reference numerals except that they will be within the 400 series.

More particularly, as can readily be appreciated from a comparison of the third and fourth embodiment header-chute assemblies 300,400, as respectively disclosed and illustrated within FIGS. 3 and 4, the only significant difference between the third and fourth embodiment header-chute assemblies 300, 400 resides in the fact that in lieu of the three-piece rotary joint characteristic of the third embodiment header-chute assembly 300 as disclosed within FIG. 3, and as defined by means of the external arcuate female socket member 308, the internal hollow tubular male member 310, and the locking insert member 314, the fourth embodiment header-chute assembly 400, as disclosed within FIG. 4, comprises a two-piece rotary joint defined by means of an external arcuate female socket member 408 and a solid internal male member 410 disposed within the female socket member 408. As was the case with the third embodiment header-chute assembly 300, as disclosed within FIG. 3, the external arcuate female socket member 408 of the fourth embodiment header-chute assembly 400 is integrally formed upon the downstream or outlet end portion of the header component 402, while the solid internal male member 410 is fixedly secured to the upstream or inlet end portion 412 of chute component 404 by means of a flanged portion 418 which may be fixedly secured to the upstream or inlet end portion 412 by any suitable means as was discussed in connection with the fixation of the first and second zipper-type fastener attachment implements 110, 114 disclosed in connection with the first embodiment header-chute assembly 100. As can readily be appreciated still further, the solid internal male member 410 may be snap-fitting inserted into, retained within, and removed from the external female socket member 408 as a result of, for example, the flexible expansion and contraction characteristics of the external arcuate female socket member 408.

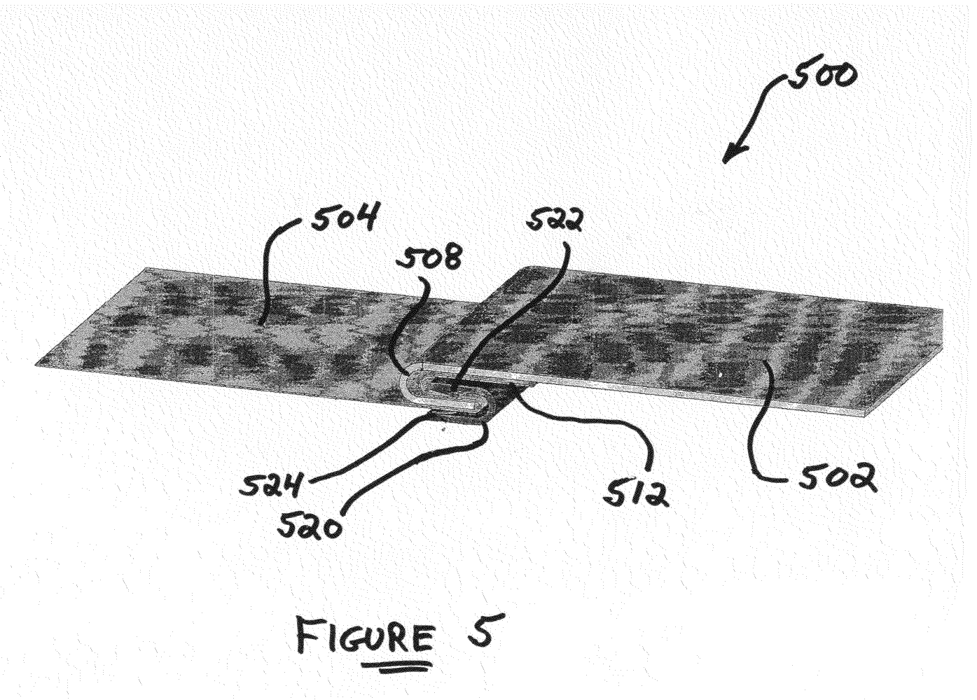

Referring now to FIG. 5, a fifth embodiment of a new and improved header-chute assembly, also constructed in accordance with the principles and teachings of the present invention and having new and improved attachment implements fixedly disposed upon, or integrally incorporated into, the header and chute components of the new and improved header-chute assembly for attachably and detachably securing together the header and chute components which are to be used within refrigeration systems incorporated within, for example, refrigeration truck or reefer trailers, is disclosed and is generally indicated by the reference character 500. It is to be noted that the fifth embodiment header-chute assembly 400 is somewhat similar to the previous embodiment header-chute assemblies 100, 200, 300, 400 as disclosed within FIGS. 1-4, and therefore a detailed discussion of the same will be omitted herefrom for brevity purposes, the discussion of the fifth embodiment header-chute assembly 500 being confined to the differences between the fifth embodiment header-chute assembly 500 and the previous embodiment header-chute assemblies 100, 200, 300, 400. In addition, in view of the broad similarity of the fifth embodiment header-chute assembly 500 to the previous embodiment header-chute assemblies 100, 200, 300, 400, component parts of the fifth embodiment header-chute assembly 500, that correspond to the component parts of the previous embodiment header-chute assemblies 100, 200, 300, 400 will be designated by corresponding reference numerals except that they will be within the 500 series.

More particularly, it is seen that in accordance with the principles and teachings of the fifth embodiment header-chute assembly 500 of the present invention, the downstream or outlet end portion 508 of the header component 502 is folded downwardly or inwardly so as to be integrally formed into an attachment or connector implement having a substantially C-shaped cross-sectional configuration, while the upstream or inlet end portion 512 of the chute component 504 is integrally formed into a mating attachment or connector implement, having a substantially S-shaped cross-sectional configuration, wherein it can be seen that the lower arcuate section of the attachment or connector implement 512 effectively encases or covers the free end portion of the attachment or connector implement 508 while the upper arcuate section of the attachment connector or implement 512 is effectively disposed internally within the C-shaped attachment connector or implement 508. Still further, a clamping member 520, also having a substantially C-shaped cross-sectional configuration, is adapted to be mounted, in a reversely oriented mode, upon the free end portion of the attachment or connector implement 508 so as to effectively encase both the free end portion of the attachment or connector implement 508 as well as the lower arcuate section of the attachment connector or implement 512 encasing or covering the free end portion of the attachment or connector implement 508.

In addition, in order to ensure that the clamping member 520 is retained upon the header-chute assembly 500 so as to clampingly engage the header and chute components 502, 504 together, the upper and lower internal free end portions of the clamping member 520 are respectively provided with resilient fingers 522, 524. In this manner, when the clamping member 520 is mounted upon or over the mated free end portions 508, 512 of the header and chute components 502, 504, the fingers 522, 524 will flex inwardly and thereby permit the clamping member 520 to in fact be relatively easy to mount upon or over the mated free end portion 508, 512 of the header and chute components 502, 504, however, when the clamping member 520 is to be removed from the header and chute components 502, 504 of the header-chute assembly 500, so as to enable the header and chute components 502, 504 to be detached from each other, the fingers 522, 524 will tend to impede such movement of the clamping member 520. Of course, it is to be realized that the clamping member 520 can nevertheless be removed relatively easily from the mated header and chute components 502, 504 as a result of, for example, service or maintenance personnel using suitable tools in order to manually deflect the fingers 522, 524 inwardly.

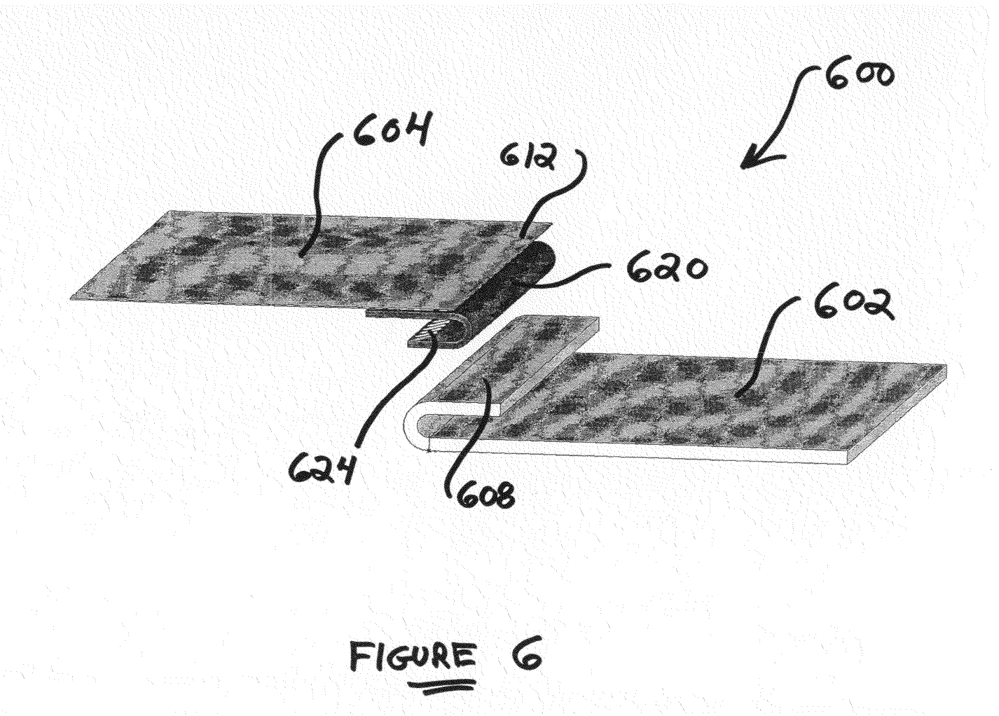

With reference now being lastly made to FIG. 6, a sixth embodiment of a new and improved header-chute assembly, also constructed in accordance with the principles and teachings of the present invention and having new and improved attachment implements fixedly disposed upon, or integrally incorporated into, the header and chute components of the new and improved header-chute assembly for attachably and detachably securing together the header and chute components which are to be used within refrigeration systems incorporated within, for example, refrigeration truck or reefer trailers, is disclosed and is generally indicated by the reference character 600. It is to be noted that the sixth embodiment header-chute assembly 600 is similar to the fifth embodiment header-chute assembly 500 as disclosed within FIG. 5, except as will be described shortly hereinafter, and therefore a detailed discussion of the same will be omitted herefrom for brevity purposes, the discussion of the sixth embodiment header-chute assembly 600 being confined to the difference between the sixth embodiment header-chute assembly 600 and the fifth embodiment header-chute assembly 500. In addition, in view of the broad similarity of the sixth embodiment header-chute assembly 600 to the fifth embodiment header-chute assembly 500, component parts of the sixth embodiment header-chute assembly 600, that correspond to the component parts of the fifth embodiment header-chute assembly 500, will be designated by corresponding reference numerals except that they will be within the 600 series.

More particularly, it is seen that, in accordance with the principles and teachings of the sixth embodiment header-chute assembly 600 of the present invention, and contrary to the downstream or outlet end portion of the header component 602 being folded downwardly and inwardly as was the case of the downstream or outlet end portion 508 of the header component 502 of the fifth embodiment header-chute assembly 500 as disclosed within FIG. 5, the downstream or outlet end portion 608 of the header component 602 of the sixth embodiment header-chute assembly 600 is folded upwardly and outwardly so as to be integrally formed into an attachment or connector implement having a substantially C-shaped cross-sectional configuration. In addition, in lieu of having a clamping member, such as, for example, the clamping member 520, wherein the clamping member 520 comprised an assembly component which is separately attachable and detachable with respect to both the header and chute components 502, 504, as was the case with the fifth embodiment header-chute assembly 500 as disclosed within FIG. 5, the clamping member 620 of the sixth embodiment header-chute assembly 600, which has a substantially C-shaped cross-sectional configuration, has its upper surface portion fixedly attached to a lower or under-surface portion of the upstream or inlet end portion 612 of the chute component 604. The free end portion of the attachment or connector implement 608 is then able to be inserted into the C-shaped clamping member 620, when it is desired to operatively connect the header and chute components 602, 604 together, so as to attachably and detachably connect the header and chute components 602, 604 together in order to form the header-chute assembly 600.

Thus, it may be seen that in accordance with the various principles and teachings of the present invention, there has been disclosed several embodiments of new and improved header-chute assemblies, having new and improved attachment implements mounted upon, or used in conjunction with, the header and chute components of the header-chute assemblies, such that the header and chute components, or successive chute components, can be easily, readily, and quickly attached and detached with respect to each other for use in conjunction with reefer or refrigeration systems incorporated within reefer or refrigeration trailers. In this manner, the header and chute components can be secured together by end-user or customer personnel at on-site or field locations so as to eliminate the need for header-chute assembly production lines, and in addition, individual or particular header and chute components can be mixed and matched as may be desired. Still further, successive chute components can be attached or detached with respect to each other in order to provide header-chute assemblies of varying length dimensions as may be required, and still yet further, worn or damaged header and chute components may be readily, easily, and quickly exchanged, interchanged, or replaced.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by letters Patent of the United States of America, is:

1. A header-chute refrigerated air distribution assembly for use in connection with refrigeration systems, comprising:
a header component to be mated with a refrigeration unit for receiving refrigerated air from the refrigeration unit;
a chute component to be mated with said header component for distributing the refrigerated air through a refrigeration container; and
first and second fastener means, respectively disposed upon said header and chute components, for attachably and detachably securing said header and chute components together.

2. The header-chute assembly as set forth in claim 1, wherein:
said first fastener means is disposed upon a down-stream outlet end portion of said header component; and
said second fastener means is disposed upon an up-stream inlet end portion of said chute component.

3. The header-chute assembly as set forth in claim 1, wherein:
said first and second fastener means comprises zipper-type fastener attachment implements.

4. The header-chute assembly as set forth in claim 1, wherein:
said first and second fastener means comprises hook and loop type fastener attachment implements.

5. The header-chute assembly as set forth in claim 1, wherein:
said first and second fastener means comprises male and female socket type fastener attachment implements.

6. The header-chute assembly as set forth in claim 1, further comprising:
clamping means for securing together said first and second fastener means of said header and chute components.

7. A refrigerated air distribution assembly for use in connection with refrigeration systems, comprising:
a first component for distributing refrigerated air, received from a refrigeration unit, into a refrigeration container;
a second component to be mated with said first component for distributing the refrigerated air through the refrigeration container; and
first and second fastener means, respectively disposed upon said first and second components, for attachably and detachably securing said first and second components together.

8. The distribution assembly as set forth in claim 7, wherein:
said first component comprises a header component to be mated with the refrigeration unit; and
said second component comprises a chute component to be mated with said header component.

9. The distribution assembly as set forth in claim 7, wherein:
said first component comprises a first chute component; and
said second component comprises a second chute component to be mated with said first chute component.

10. The distribution assembly as set forth in claim 7, wherein:
said first fastener means is disposed upon a down-stream outlet end portion of said first component; and
said second fastener means is disposed upon an up-stream inlet end portion of said second component.

11. The distribution assembly as set forth in claim 7, wherein:
said first and second fastener means comprises zipper-type fastener attachment implements.

12. The distribution assembly as set forth in claim 7, wherein:
said first and second fastener means comprises hook and loop type fastener attachment implements.

13. The distribution assembly as set forth in claim 7, wherein:
said first and second fastener means comprises male and female socket type fastener attachment implements.

14. The distribution assembly as set forth in claim 7, further comprising:
clamping means for securing together said first and second fastener means of said first and second components.

15. A fastener system for use with first and second distribution components of a refrigerated air distribution assembly used in connection with refrigeration systems, comprising:
first and second fastener means, respectively disposed upon first and second distribution components of a refrigerated air distribution assembly used in connection with refrigeration systems, for attachably and detachably securing the first and second distribution components together.

16. The fastener system as set forth in claim 15, wherein:
said first fastener means is adapted to be disposed upon a downstream outlet end portion of the first distribution component; and
said second fastener means is adapted to be disposed upon an upstream inlet end portion of the second distribution component.

17. The fastener system as set forth in claim 15, wherein:
said first and second fastener means comprises zipper-type fastener attachment implements.

18. The fastener system as set forth in claim 15, wherein:
said first and second fastener means comprises hook and loop type fastener attachment implements.

19. The fastener system as set forth in claim 15, wherein:
said first and second fastener means comprises male and female socket type fastener attachment implements.

20. The fastener system as set forth in claim 15, further comprising:
clamping means for securing together said first and second fastener means of the first and second distribution components.
